(19) United States
(12) Patent Application Publication
(10) Pub. No.: US 2017/0342964 A1
(43) Pub. Date: Nov. 30, 2017

(54) Wind Turbine Energy Tube Battery Charging System for a Vehicle

(71) Applicant: Frank P. Cianflone, Thornwood, NY (US)

(72) Inventor: Frank P. Cianflone, Thornwood, NY (US)

(21) Appl. No.: 15/605,606

(22) Filed: May 25, 2017

Related U.S. Application Data
(60) Provisional application No. 62/342,042, filed on May 26, 2016.

(51) Int. Cl. F03D 9/32; F03D 3/00; B60L 8/00; F03D 9/25; B60K 16/00

(52) U.S. Cl. CPC F03D 9/32; B60L 8/006; F03D 9/25; F03D 3/002; B60K 2016/006; F05B 2240/941

(57) ABSTRACT

The present application discloses wind-powered charging systems and methods for an electric vehicle. The present system can be located within tube structure on the interior of a vehicle and can comprises one or more intake ports such that, when the car is in motion, air flows into the intake ports. The intakes ports are operatively connected to at least one wind turbine, each wind turbine having a self-contained alternator and blades, the alternator being located interior to the blades. In operation, the air flow from the intake port rotates the blades of the turbine to generate electricity (AC or DC electricity) in the alternator, which is used to charge one or more batteries of the vehicle. The electricity created in the alternator can be used to produce more than one voltage output such that batteries of different voltages can be charged simultaneously.

### CROSS-REFERENCE TO RELATED PATENT APPLICATIONS

This application is based on and claims priority to U.S. Provisional Patent Application 62/342,042, filed May 26, 2016, the entire contents of which is incorporated by reference herein as if expressly set forth in its respective entirety herein.

### TECHNICAL FIELD

The present application relates to the use of wind power for powering electric vehicles and re-charging their batteries while driving. More specifically, the present application relates to the use of wind turbines for generating electrical power for electric vehicles and addresses the need for additional power required in autonomously driven electric cars.

### BACKGROUND

Electric cars are becoming a viable alternative to gasoline or diesel-powered vehicles. Electric vehicles typically use a series of batteries, such as lithium ion batteries, and one or more electric motors, and the batteries can be charged via electricity from the power grid. Electric cars provide several benefits over conventional gasoline or diesel-powered vehicles, including being more environmentally-friendly, as electric cars do not emit greenhouse gases. Further, electric cars produce less roadway noise as compared with their gasoline and diesel-powered counterparts.

However, despite the benefits associated with electric cars, the number of electric cars on the road still remains small relative to gasoline or diesel-powered vehicles. One reason for the lack of electric cars is the limited distance that electric cars can travel before the batteries must be recharged (called “range”). This not only poses a practical limitation on how long of a trip a driver can plan in-between charges, but also cause fear in the mind of the driver that the one or more batteries will run out of power before he or she reaches the destination, which is termed “range anxiety.” As such, there is a need for extending the battery life of electric car batteries.

### BRIEF DESCRIPTION OF THE DRAWING FIGURES

FIG. 1 shows a perspective drawing of an exemplary electric vehicle including the wind-powered charging system, in accordance with one or more embodiments;

FIGS. 2A-B show diagrams of an embodiment of the wind-powered charging system that includes three adjacent intake ports and three adjacent wind turbines, in accordance with one or more embodiments;

FIG. 3 shows a side view of an exemplary wind turbine structure of the wind-powered charging system, in accordance with one or more embodiments;

FIG. 4 shows a partial diagram of the wind-powered charging system, which includes the wind turbine, a controller, two batteries, a charger, a motor, and a transmission, in accordance with one or more embodiments;

FIG. 5 shows a perspective drawing of an exemplary wind turbine structure inside the hood scoop of an electric vehicle, in accordance with one or more embodiments; and

FIG. 6 shows a perspective drawing of an exemplary electric vehicle, showing intake ports of the wind-powered charging system in the grille and on the roof of a vehicle, in accordance with one or more embodiments.

### DETAILED DESCRIPTION OF CERTAIN EMBODIMENTS

The present application relates to the use of wind powered turbines for generating electrical power for electric vehicles. In particular, the present application discloses wind-powered charging systems and methods for an electric vehicle. In one or more embodiments, the present system comprises one or more intake ports (air flow manifold or first tube) located within the grille of the vehicle. While the car is in motion, air flow enters the one or more intake ports. At the end of each intake port is at least one wind turbine disposed within a second tube, each wind turbine having a self-contained alternators and blades. Unique to the present design, the alternator is built into the rotating blades section of the generator tube and includes an inner tube comprising magnets on the inside of the tube, and a stationary magnetic coil (windings) attached to the horizontal hub. The blades are located on the outside of the inner tube. In operation, the air flow from the intake port is directed through and rotates the blades and inner tube of the turbine around the horizontal hub, thereby causing the magnets of the inner tube to rotate around the magnetic coil to generate electricity (AC or DC electricity) at the horizontal hub. As the blades rotate, the air flow is directed past the blades, through an exhaust vessel and out of an exhaust port, where the air flow exits to the outside of the vehicle. The hood over the rotating blades extends past the blades and helps the air flow to pass to the outside of the vehicle, thus reducing resistance and increasing efficiency.

The self-contained alternator is designed to have more than one voltage output. For example, the alternator can comprises one section of the magnetic coil (windings) that produces relatively low voltage output (e.g., 12 volts), and a second section of the magnetic coil (windings) that produces a relatively high voltage output (e.g., 300 volts). The low voltage output is designed for battery re-charging, while the high voltage output is designed for vehicle propulsion.

In one or more embodiments, the wind-powered charging system of the present application can be located within the hood of the vehicle, and can comprise a separate manifold cover to separate the wind turbine from other components of the vehicle located in the hood such as the engine or transmission. In one or more embodiments, the exhaust vessel must extend from the wind turbine far enough to create a low-pressure zone outside of the outer tube housing the wind turbine in order to efficiently pull the air through the exhaust vessel and out the exhaust port, thus reducing resistance. In other embodiments, the system can reside in other parts of the electric vehicle, and can be of various sizes and placement on vehicle as to adopt to the aerodynamic design of said vehicle and the efficiency of its air flow past vehicle.

The systems of the present application can extend the range of existing electric or hybrid and autonomous vehicles. In certain embodiments, the systems of the present application can extend the range of an electric car by as much as 200% or more. Additionally, the systems of the present application can reduce the need for as much as 50% of the number of batteries that are currently required for electric cars, thereby allowing for a lighter, more efficient, and more inexpensive vehicle. In certain embodiments, the system can use the electric vehicle's speed to power the on-board recharger, power the vehicle, and re-charge the batteries while driving. The systems of the present application also eliminate the need for blade braking and cut-out, and is capable of operating at speeds in excess of 80 to 100 mph. In certain embodiments, the system can be made of lightweight materials, thus contributing to the overall reduction in vehicle weight.

The referenced wind-powered charging systems and methods for an electric vehicle are now described more fully with reference to the accompanying drawings, in which one or more illustrated embodiments and/or arrangements of the systems and methods are shown. The systems and methods are not limited in any way to the illustrated embodiments and/or arrangements as the illustrated embodiments and/or arrangements described below are merely exemplary of the systems and methods, which can be embodied in various forms, as appreciated by one skilled in the art. Therefore, it is to be understood that any structural and functional details disclosed herein are not to be interpreted as limiting the systems and methods, but rather are provided as a representative embodiment and/or arrangement for teaching one skilled in the art one or more ways to implement the systems and methods. Furthermore, the terms and phrases used herein are not intended to be limiting, but rather are to provide an understandable description of the systems and methods.

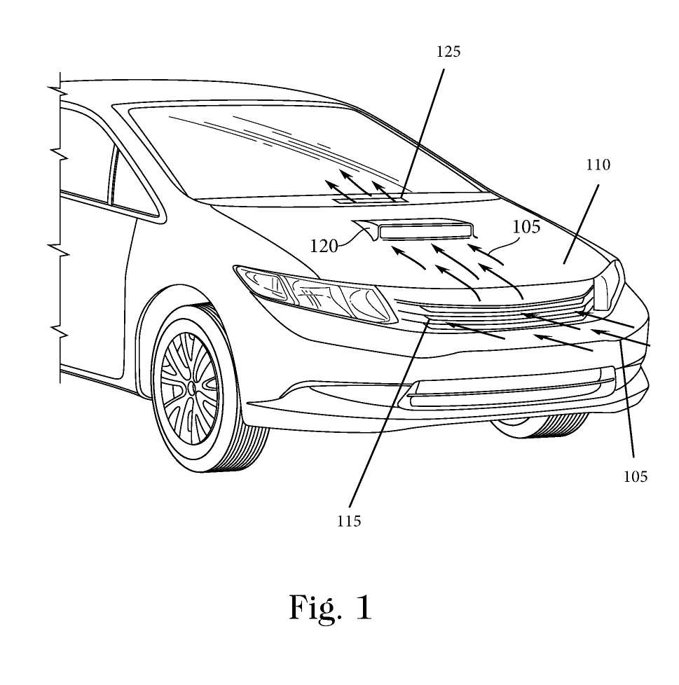

An exemplary electric vehicle comprising a wind-powered regenerative charging system of the present application is shown in FIG. 1. As shown by FIG. 1, air flow 105 can enter the hood 110 of the electric vehicle via one or more entry points. The hood 110 comprises one or more intake ports (not shown) and one or more wind turbines (not shown). The air flow 105 entering the hood 110 (and subsequently, the intake ports) causes the wind turbine(s) to spin, thereby creating electrical energy as discussed in greater detail below. In the embodiment of FIG. 1, the air flow 105 can enter the hood 110 of the vehicle via the grille 115 and/or a hood scoop 120. After passing through hood 110 of the electric vehicle and activating the one or more wind turbines (not shown), the air flow 105 can exit the hood 110 via an exhaust port 125. In this embodiment, the exhaust ports 125 are located adjacent to the windshield; however, in one or more embodiments, the one or more exhaust ports 125 can be located in other locations adjacent to the hood 110, such on the side of the electric vehicle behind one or both of the front wheels or on the roof of the vehicle. The air flow 105, after passing through the wind turbine, must exit the system (via the exhaust port 125) in order to avoid producing resistance and lowering the efficiency of the system.

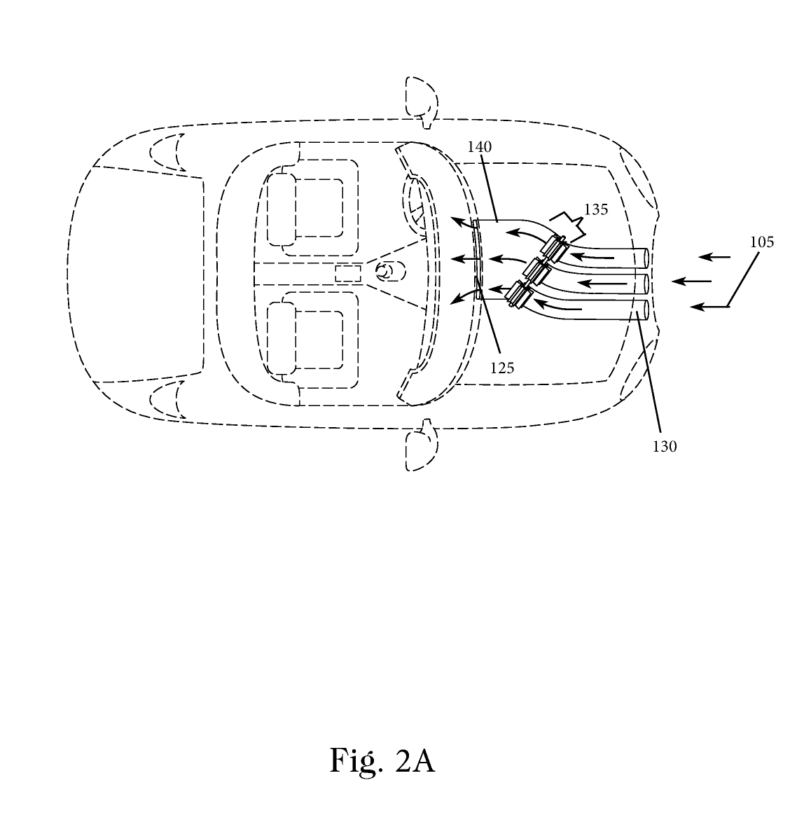

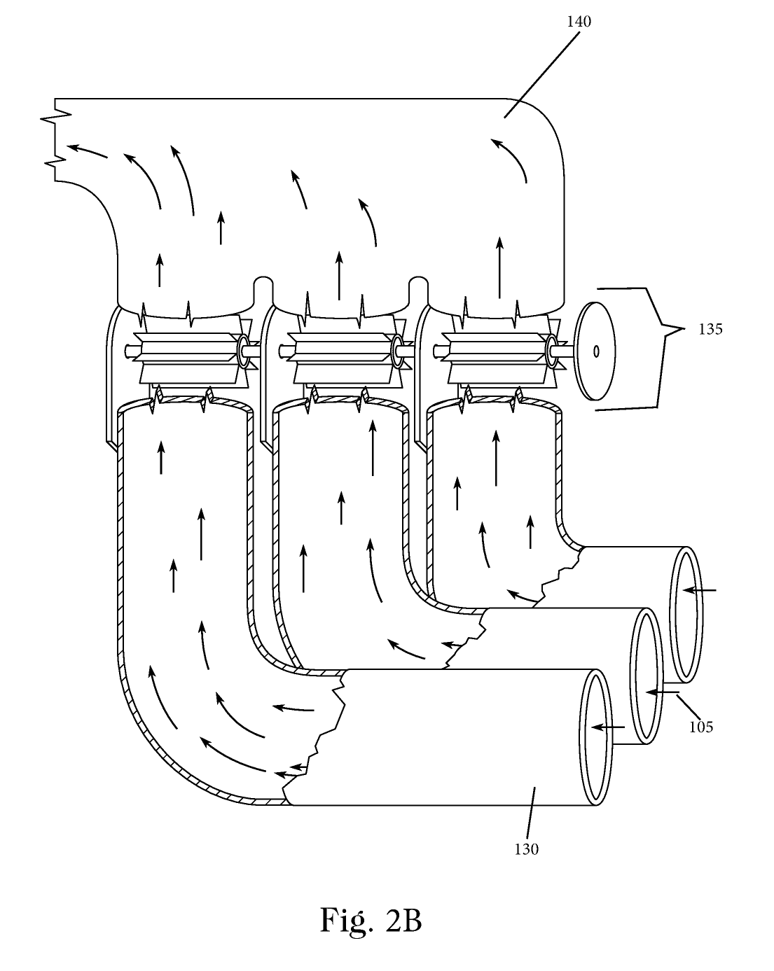

FIG. 2A shows a top view of an exemplary wind-powered charging system of the present application. As shown in FIG. 2A, in at least one embodiment, the air flow 105 enters the hood of the vehicle (e.g., via the grille), and then enters one or more intake ports 130. FIG. 2A shows a series of three intake ports 130, however in one or more embodiments, any number of intake ports can be used. For example, in at least one embodiment, the air flow 105 firsts enter a manifold intake port, and the air flow 105 is then directed from the manifold intake port into a plurality of intake ports 130. In at least one embodiment, the intake ports 130 can be located within a first tube separating the intake ports from the other components in the hood of the vehicle. Further, while FIG. 2A shows intake ports 130 in a cylindrical shape, it should be understood that the intake ports can be of many shapes, including but not limited to rectangular and/or square-shaped.

After entering the one or more intake ports 130, the air flow 105 is directed to a wind turbine 135. In the embodiment FIG. 2A, each intake port 130 has its own wind turbine 135; however, in at least one embodiment, all intake ports 130 can direct the air flow 105 to one wind turbine. As explained in greater detail below, the force of the air flow 105 flowing through the intake port 130 causes the wind turbine 135 to rotate, thereby generating electricity to be used for charging the battery of the electric vehicle.

As shown in FIG. 2A, after passing through the wind turbines 135, the air flow 105 flows into an exhaust vessel 140 that directs the air flow to the exhaust port 125 where it exits the system. While FIG. 2A shows a single exhaust vessel 140, in one or more embodiments, each wind turbine 135 can direct the air flow 105 to respective exhaust vessels, and the multiple exhaust vessels can then direct the air flow 105 to the exhaust port 125 to exit the system. FIG. 2B shows a zoomed in top view of the exemplary wind-powered charging system of FIG. 2A, showing the intake ports 130, wind turbines 135, and the exhaust vessel 140. In one or more embodiments, the exhaust vessel 140 must extend from the wind turbine 135 far enough to create a low-pressure zone outside of the outer tube housing the wind turbine in order to efficiently pull the air through the exhaust vessel 140 and out the exhaust port 125, thus reducing resistance.

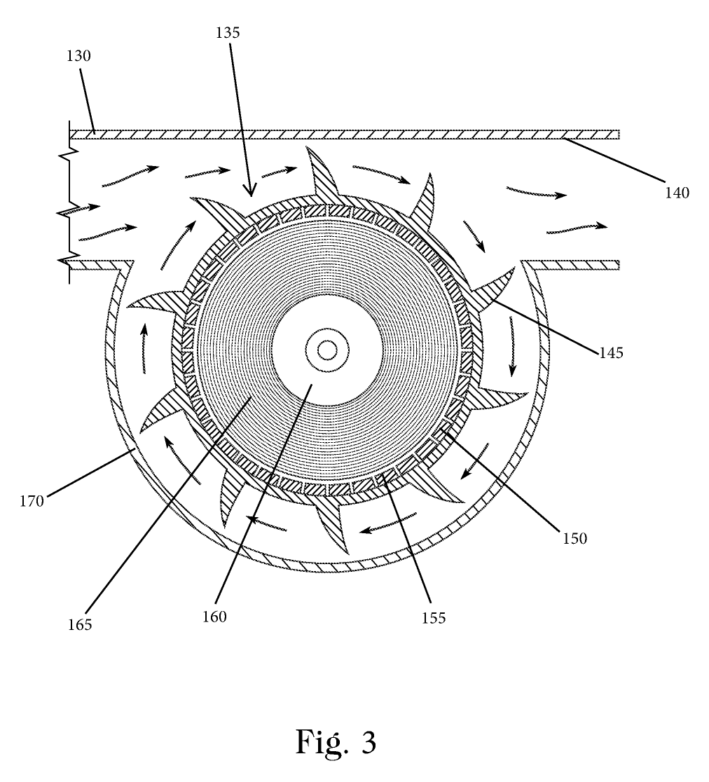

A side view of an exemplary wind turbine and alternator structure of the wind-powered charging system is shown at FIG. 3, in accordance with one or more embodiments. As shown in FIG. 3, the wind turbine 135 comprises a plurality of blades 145 that are disposed on the outer surface of an inner tube 150. Disposed on the inner surface of the inner tube 150 is a plurality of magnets 155. The wind turbine 135 further comprises a center hub (shaft) 160, which is surrounded by a magnetic coil (windings) 165. The magnetic coil 165 can comprise copper, for example, or other electromagnetic materials known in the art. The wind turbine 135 is disposed within an outer tube 170 that is fluidly connected to the intake port 130 and the exhaust vessel 140.

The air flow 105 passing through the intake port 130 causes the blades 145 of the turbine 135 to rotate. Because the blades 145 are disposed on the inner tube 150, the inner tube 150 and the plurality of magnets 155 also rotate. While the inner tube 150 (including blades 145 and magnets 155) rotates in response to the air flow 105, the hub 160 and the magnetic coils 165 remain stationary. In one or more embodiments, the wind turbine 135 can comprise ball bearings (not shown) that allow the inner tube 150 to rotate around the hub 160.

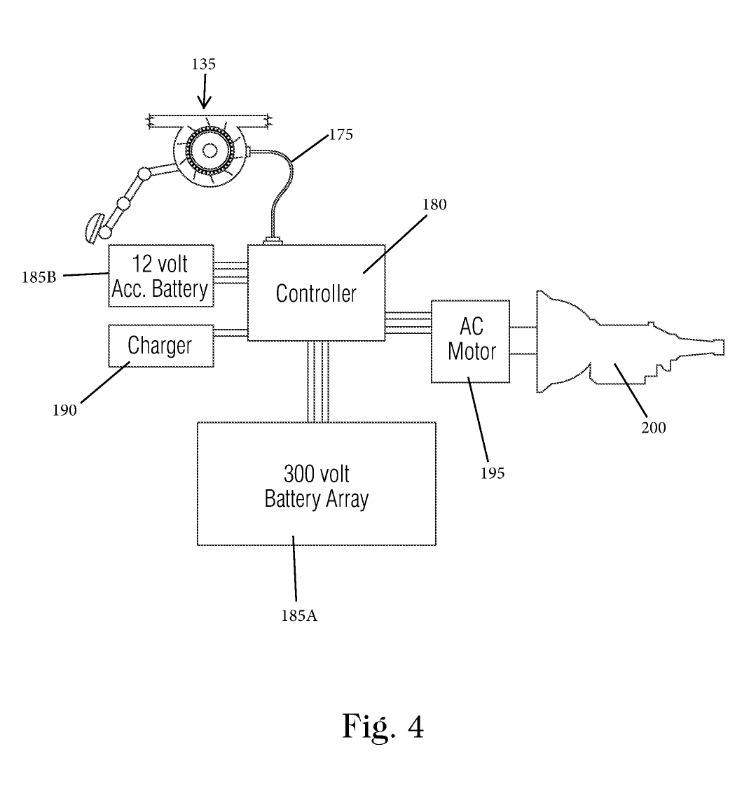

The rotating magnets 155 and the stationary magnetic coils 165 make up the self-contained alternator structure. As such, the rotation of the magnets 155 around the magnetic coils 165 results in the creation of an electromagnetic field and, subsequently, the generation of an electric current (e.g., AC or DC electricity) in the magnetic coils 165. The electric current generated in the coils 165 can then be harnessed by the system (e.g., using connective wiring connected to the coils 165), and used to charge the battery of the electric vehicle, as explained below with reference to FIG. 4.

FIG. 4 shows a partial diagram of the wind-powered charging system, which includes connective the wind turbine 135, connective wiring 175, a controller 180, at least one battery 185, a charger 190, a motor 195, a transmission 200, in accordance with one or more embodiments. As mentioned above, the electric current generated in the coil 165 of the wind turbine 135 is harnessed by the system using connective wiring 175 formed of a conductive material. The electric energy is then transferred from the connective wiring 175 via a controller 180 to the battery 185. More specifically, the controller 180 regulates the voltage of the electric current that is then used to the charge the battery 185. As mention above, the alternator can comprises one section of the magnetic coil (windings) that produces relatively low voltage output (e.g., 12 volts), and a second section of the magnetic coil (windings) that produces a relatively high voltage output (e.g., 300 volts). Further, the system can comprise multiple batteries such that each voltage output can charge one or more different batteries. For example, as shown in FIG. 4, the system comprises a 300-volt battery 185A (a typical electric vehicle battery) and a 12-volt battery 185B (a standard automotive battery). As such the electric current created in the coils can have more than one voltage output (e.g., 300 volts, 12 volts) from the controller to match each battery. Thus, in the embodiment of FIG. 4, the electric current from the wind turbine can be used the charge both the electric vehicle battery 185A (for providing power to the motor 195 and transmission 200 for vehicle propulsion) and the standard automotive battery 185B (for providing power for standard accessories of a car).

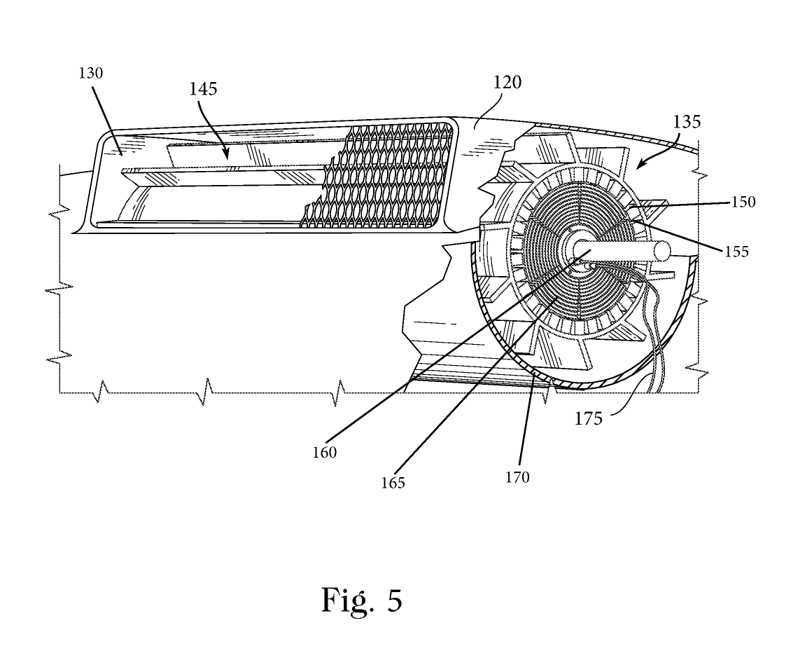

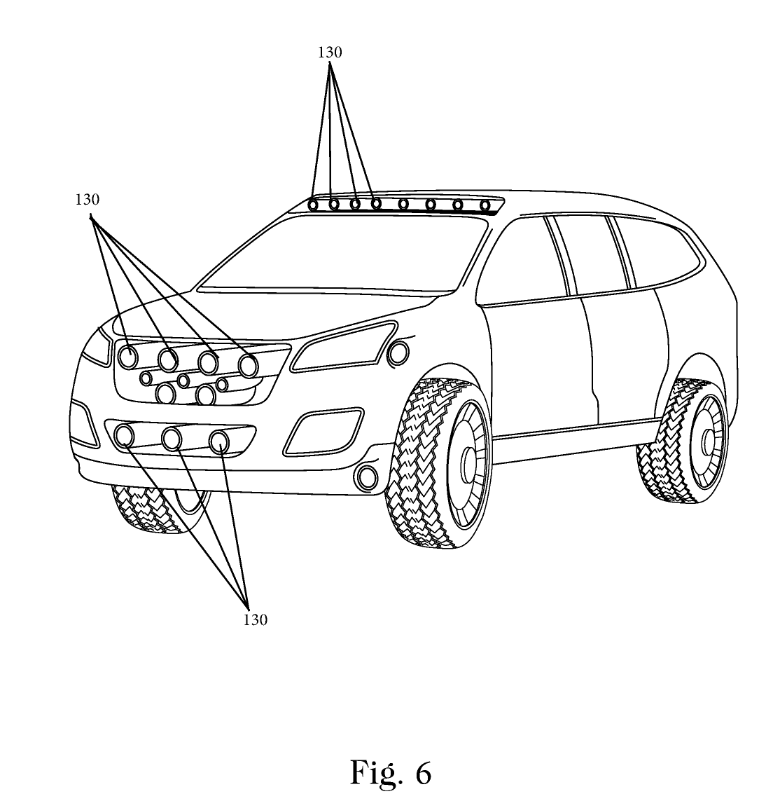

FIG. 5 shows an alternative embodiment in which a single wind turbine 135 is located within the hood of the electric vehicle behind the hood scoop 120. As shown in FIG. 5, the wind turbine 135 is housed within the outer tube 170, which is fluidly connected to the intake port 130 and the exhaust vessel 140. While the figures and embodiments discussed above have shown the wind turbine system being located within the hood of the vehicle, it should be understood that in one or more implementations, the wind turbine system can be located in other locations on the vehicle. For example, as shown in FIG. 6, in at least one embodiment, a wind turbine system can be located within the roof of the vehicle. Specifically, FIG. 6 not only shows a plurality of intake ports 130 in the grill of the vehicle, but also shows a plurality of intake ports 130 within the roof of the vehicle, which can be fluidly connected to one or more wind turbines within the roof of the vehicle (not shown). While the embodiment of FIG. 6 has wind turbine systems in both the hood and the roof of the vehicle, it should be understood that in at least one embodiment, the vehicle can have a wind turbine system in only one of those locations, or in a separate location on the vehicle, such as the trunk.

Further, it should be understood that the dimensions of the wind turbine system, including the number of intake and exhaust ports, the size of the one or more wind turbines, the number of batteries, and voltages of those batteries, are flexible and are determined at least in part by the vehicle's power needs and the vehicle's design. Power output is of the wind turbine system is determined at least in part by the length of the intake port and exhaust vessels, air flow speed, and blade RPMs. In at least one preferred embodiment, the wind turbine system of the present application is designed to operate at high RPMs. Finally, the wind turbine system of the present application, in certain embodiments, can be contained within one or more tubes separating the system, in whole or in part, from the other components of the vehicle.

The subject matter described above is provided by way of illustration only and should not be construed as limiting. The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components, and/or groups thereof.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

Further, various modifications and changes can be made to the subject matter described herein without following the example embodiments and applications illustrated and described, and without departing from the true spirit and scope of the present invention.

What is claimed is:

1. A wind turbine energy tube battery charging system for a vehicle comprising:
a rechargeable battery;
a controller in electrical communication with the rechargeable battery; and
a self-contained wind turbine based alternator including:
an outer housing that is fluidly connected to an air intake port of the vehicle and an exhaust port of the vehicle; and
a rotatable wind turbine assembly disposed within and surrounded by the outer housing such that at least an upper portion thereof extends above the outer housing so as to be in fluid communication with the air intake port and the exhaust port, the wind turbine assembly including a center shaft which is surrounded by a magnetic coil, a turbine housing that surrounds the magnetic coil and includes along an inner surface thereof a plurality of magnets facing the magnetic coil and a plurality of blades protruding and extending radially outward from an outer surface thereof; wherein tips of the plurality of blades face and are proximate an inner surface of the outer housing.

2. The system of claim 1, wherein at least a substantial portion of the rotatable wind turbine assembly is seated within the outer housing.

3. The system of claim 1, wherein the air intake port is defined by a first wall and a spaced second wall with a hollow space formed therebetween and the exhaust port is defined by a first wall and a spaced second wall with a hollow space formed therebetween, the second wall of the air intake port being integrally formed with a top edge of one side of the outer housing and the second wall of the exhaust port being integrally formed with a top edge of an opposing side of the outer housing.

4. The system of claim 1, wherein the outer housing has a partial cylindrical shape that extends greater than 180 degrees.

5. The system of claim 1, wherein the first wall of the air intake port and the first wall of the exhaust port comprise a single continuous wall.

6. The system of claim 1, wherein a portion of the rotatable wind turbine assembly is disposed within a fluid flow path that lies between the first wall and the second wall of each of the air intake port and the exhaust port.

7. The system of claim 1, wherein tips of the turbine blades are disposed proximate the first wall of each of the air intake port and the exhaust port.

8. The system of claim 6, wherein the rotatable wind turbine assembly lies at least partially within the fluid flow path.

9. The system of claim 1, wherein the turbine housing has a cylindrical shape.

10. The system of claim 1, wherein the magnetic coil is configured to generate an electric current during operation of the self-contained wind turbine based alternator and is electrically connected to the batter by a connective wire that passes through and is in electrically contact with the controller.

11. The system of claim 1, wherein the battery comprises a plurality of batteries, each connected to the controller.

12. The system of claim 1, wherein the self-contained wind turbine based alternator is configured for placement along a panel of the vehicle with the air intake port and the exhaust port both being exposed to atmosphere.

13. The system of claim 1, wherein the outer housing covers and surrounds at least 60% of a circumference of the rotatable wind turbine assembly.

14. The system of claim 1, wherein the outer housing covers and surrounds at least 70% of a circumference of the rotatable wind turbine assembly.

15. The system of claim 1, wherein the air intake port and the exhaust port are coaxial and define a fluid flow space in which fluid flows into contact with the rotatable wind turbine assembly and exits through the exhaust port, the outer housing lying below the fluid flow space with an upper portion of the rotatable wind turbine assembly being disposed within the fluid flow space.

16. A wind turbine energy tube for use in a battery charging system of a vehicle comprising:
an outer housing that is fluidly connected to an air intake port of the vehicle and an exhaust port of the vehicle, the outer housing having first wall and a spaced second wall with a hollow space formed therebetween, the second wall having a concave shaped portion that defined a concave shaped receiving space; and
a rotatable wind turbine assembly at least partially disposed within the concave shaped receiving space such that at least an upper portion thereof extends above the second wall so as to be in fluid communication with the air intake port and the exhaust port, the wind turbine assembly including a center shaft which is surrounded by a magnetic coil, a turbine housing that surrounds the magnetic coil and includes along an inner surface thereof a plurality of magnets facing the magnetic coil and a plurality of blades protruding and extending radially outward from an outer surface thereof; wherein tips of the plurality of blades face and are proximate an inner surface of the outer housing.
